(19) United States
(12) Patent Application Publication
(10) Pub. No.: US 2006/0111933 A1
(43) Pub. Date: May 25, 2006

(54) Adaptive medical decision support system

(76) Inventor: Steven Wheeler, Calgary (CA)

Correspondence Address: EDWARD YOO C/O BENNETT JONES, 1000 ATCO CENTRE, 10035 - 105 STREET, EDMONTON, ALBERTA, AB, T5J3T2, CA

(21) Appl. No.: 10/525,772

(22) PCT Filed: Oct. 8, 2004
(86) PCT No.: PCT/CA04/01817

§ 371 Date: Nov. 16, 2005

Related U.S. Application Data
(60) Provisional application No. 60/481,492, filed on Oct. 9, 2003.

(51) Int. Cl. G06Q 10/00; G06Q 99/00; G06Q 50/00; G05B 19/418

(52) U.S. Cl. 705/2; 705/1; 705/8

(57) ABSTRACT

A method and system for providing diagnostic and treatment information to a health professional is disclosed. A set of diagnostic and treatment rules are applied to patient specific information inputted by the health professional during an adverse medical event. The system then selects and delivers appropriate diagnoses and treatment algorithms in response to various user inputs. An outcome analysis module receives actual treatment and response data which may then be used to confirm or modify the diagnostic and treatment rules.

### FIELD OF THE INVENTION

The present invention relates to a computer-implemented expert system for medical decision making support and outcome analysis, which permits adaptive revisions of diagnosis and treatment rules based on outcome analysis.

### BACKGROUND OF THE INVENTION

The body of medical knowledge available to a physician is rapidly expanding and it is now impossible for even specialists to be fully informed of the state of the art in differential diagnoses and treatment methods and alternatives. The sheer volume of available information compounds the existing difficulty of recalling diagnoses and treatment algorithms during adverse medical events, and particularly during crisis situations. There is an abundance of reference material available in the form of textbooks and journal articles, or more recently, on the Internet.

However, in a crisis situation, a physician does not have time to locate and review a textbook, or a journal article, either in hardcopy or on the Internet. Furthermore, this reference material cannot take into account the patient's specific medical condition or ongoing treatment because it comprises a generic list of diagnoses or a generic treatment algorithm. As a result, the best possible care for a patient is often not available.

Treatment algorithms in many instances are quite complicated, to the extent that it is difficult to remember each step of the algorithm, and even more difficult to remember each step in correct order. This is particularly true with algorithms that are rarely used or encountered by the physician.

Studies have shown that even well-trained and competent physicians routinely make errors. For example, when anesthesiologists were given 10 hypothetical clinical scenarios that required use of well-established algorithms for managing cardiac arrhythmias, fewer than 14% achieved a minimum acceptable score and avoided making any errors which would have killed a patient. 56% made at least one lethal error while attempting to apply the algorithms.

Furthermore, there is no efficient method of reporting outcomes and particularly adverse outcomes. The chill of potential legal actions and professional embarrassment typically results in information surrounding adverse outcomes not being widely disseminated. Ironically, such information is likely to be the most instructive to the profession.

Therefore, there is a need in the art for an expert system which is readily accessible by medical professionals to assist with diagnostic and treatment decision making processes. As well, there is a need in the art for methods of reporting outcomes and analyzing such outcomes in an anonymous manner such that the expert system may be beneficially modified with the knowledge obtained from such outcome analysis.

### SUMMARY OF THE INVENTION

The present invention is directed at an expert medical decision support system and the methods implemented by such systems. In its preferred embodiments, the invention may provide three key benefits. It may provide the professional with current medical decision support customized for each individual patient. Effective outcome analysis of adverse and critical events may measure patient outcomes and identify problems common to professionals in varied specialties, institutions and countries. By establishing efficient reporting structures and communication methods between outcome analysts, national patient safety organizations, patient care experts and professionals, improvements in patient care practices and likely outcomes may occur sooner.

The invention comprises two expert system modules which are separate but interact as described herein. The Diagnosis and Treatment (DT) module provides customized medical decision support to the professional. The Outcome Analysis (OA) module receives data from adverse and critical events. It will analyze the data to look for causes and efficiently report the results.

The DT module runs on a first server that is either local or remote to a hospital information system (IS). In one configuration, the DT module may be embedded within the IS. In all configurations, the DT module has access to all non-confidential patient information.

Unlike existing sources that just provide a generic algorithm, the DT module provides decision support that is customized for their particular patient. Although the DT module uses generic algorithms as a basis, the system is designed to consider each possible exception to the generic algorithm. The DT module will adapt the generic algorithms to provide information support customized to the patient's many unique issues including age, weight, location, past medical history, recent medications, current or past surgical procedures and institutional and geographically specific criteria. The rules that define the medical decision support information to be supplied may bebe developed by patient care experts. The decision support will give the professional up to date information on how to diagnose, resuscitate and treat their particular patient.

As a result of knowing the patient's current and past medical status including vital signs, the DT module will provide a list of diagnostic possibilities, the differential diagnoses, for their particular patient. In addition, it can analyze the patient's current status to determine which of the possible diagnoses have the highest probability of being the correct diagnosis.

While the professional is making the diagnosis, the DT module may concurrently provide a list of resuscitation steps that can be done to stabilize the patient long enough to complete the diagnosis and begin definitive care. Through analysis of the patient's unique problems and current vital signs, appropriate resuscitation steps can be given to the professional.

The DT module will provide the professionals with a list of customized treatments that they might use for their specific diagnosis. The system can give the professional an exact dose for each drug based on the patient's age, weight and underlying medical problems such as cardiac, liver or renal dysfunction. It can give specific mixing and delivery instructions thereby reducing the risk of drug errors.

The DT module may provide an indicator of efficacy for each possible treatment step based on the strength of research supporting the treatment.

The DT module may analyze the current generic guidelines and identify those treatments which may be recommended by the guidelines but are in fact, harmful for this particular patient. By clearly identifying harmful treatments, the risk that the professional may choose a harmful treatment for their patient may be reduced.

Although the DT module provides decision support for professionals to diagnose, resuscitate and treat patients, it is still the professional who makes all patient care decisions. The system will provide information to assist the professional while making decisions. The DT module will never make any decisions for the professional.

The DT module is adaptable to different practice conditions. The system may consider different drug names, formulations, languages and government approval status to provide appropriate decision support for professionals practicing in different countries. As medications are added or deleted from each institution's formulary, the DT module can revise its decision support. In addition, insurance companies may authorize medication use only for certain patients and the DT module can include those medications for individuals when appropriate.

With the intelligence provided by the DT module, the hospital IS may provide a user interface for professionals to view decision support and enter data. This user interface can be of any design. By anticipating the most likely actions to be made by the professional, the IS can give the user the most efficient method of receiving information and a data entry method to record data such as drugs and procedures actually given or undertaken.

The Outcome Analysis (OA) module includes a central repository of non-confidential information from patients who have undergone an adverse medical event. After every event, the OA module receives and stores the defined non-confidential data from the hospital IS.

This centralized storage site for all adverse medical event data will give outcome analysis researchers a single source in which to find relevant data. This configuration will enable researchers to focus on analyzing data instead of spending time looking for the data and gaining permission to access it.

Preferably, only non-confidential data would be received by the OA module. It would not include any information that would identify the specific patient, professional or institution. Preferably, the transmission of data from the IS to the OA module does not occur at the time of the event but may be days or weeks later. As a result, the data cannot be identified with an event which occurred on a particular day at a particular institution. In this way, outcome analysis can proceed at the soonest possible opportunity without risk to the confidentiality of patients, professionals or institutions.

It is preferred that the OA module receive data from a plurality of institutions. However, in a basic embodiment, the OA module may be associated with a single institution. With confidentiality assured, the IS can transmit data from all adverse medical events. Researchers and national patient safety organizations can have access to a complete source of all data. They will no longer be dependent on voluntary reporting.

Establishing the standards of what data must be stored before, during and after an event can be performed by the OA experts after consultation with OA researchers, national patient safety organizations and patient care experts. In this way, the data that is necessary to support changes in patient care will be collected from each event.

Through the use of intelligent outcome analysis tools, which are well known in the art, automated and customized data analysis can be done. As outcome analysis is completed, in one embodiment, a formalized reporting structure will report results immediately to one or more of national patient safety organizations, patient care experts and professionals. Combined with other research, patient care safety experts can use the outcome analysis results as a basis for modifying patient care guidelines and algorithms.

Another formalized reporting structure will ensure that DT system experts are immediately advised of any changes to patient care algorithms made by patient care experts. The DT module can then be modified to reflect these recommended changes to patient care. The DT module will then communicate the new recommendations and rationale to all connected IS's for distribution to their professionals. After sufficient testing of the new DT decision support recommendations, the DT module will be upgraded so that professionals will have access to the most up to date decision support.

Therefore, in one aspect, the invention may comprise a computer-implemented method of supplying diagnostic or treatment information, or both, to a health professional, comprising the steps of:
(a) creating a database of diagnosis and treatment rules;
(b) collecting patient-specific information;
(c) applying the diagnosis and treatment rules to the patient-specific information and determining suitable diagnostic or treatment information, or both;
(d) collecting outcome information including actual treatment and patient response information; and
(e) modifying the database of diagnosis and treatment rules in accordance with the outcome information.

The method may be relevant to critical or non-critical adverse medical events.

In another aspect, the invention may comprise a medical decision support system including a hospital information system including at least one user workstation, said system comprising:
(a) at least one server comprising:
   a database comprising diagnosis and treatment rules;
   means for modifying the diagnosis and treatment rules in accordance with outcome information;
   a database comprising patient-specific information; and
   means for generating diagnostic or treatment options by comparing the patient-specific information to the rules database;
(b) a second server, which may be the same as the at least one server, comprising a database of outcome events and outcome data, and means for generating pre-defined reports and ad-hoc reports;
(c) wherein the at least one workstation comprises:
   a data interface for collecting patient-specific information and transmitting it to the server;
   a user interface for receiving and displaying the diagnostic or treatment options; and
(d) wherein a second workstation, which may be the same as the at least one workstation, comprises:
   an outcome interface for collecting outcome information and transmitting it to the second server; and
   a report interface for receiving and displaying reports received from the second server.

### BRIEF DESCRIPTION OF THE DRAWINGS

The invention will now be described by way of an exemplary embodiment with reference to the accompanying simplified, diagrammatic, not-to-scale drawings. In the drawings:

FIG. 1 is a schematic representation of one embodiment of the present invention demonstrating the adaptive nature of the development of optimal rules arising from outcome analysis.

FIG. 2 shows the use of the present invention in connection with different medical disciplines.

FIG. 3 is a schematic diagnosis and treatment rule set development flowchart.

FIGS. 4, 4A, 4B are schematic diagnosis and treatment flowcharts.

FIG. 5 is a schematic outcome analysis flowchart.

FIG. 6 is a schematic flowchart of the application of the diagnosis and treatment rules.

FIG. 7 is a schematic block diagram of one hardware configuration of one embodiment of the present invention.

FIG. 8 is an example of a screen shot showing a user interface alternative presented after requesting decision support and lists possible patient problems

FIG. 9 is an example of a screen shot of a user interface presented after the patient problem is declared and lists differential diagnoses, resuscitation steps and potentially harmful treatments

FIG. 10 is an example of a screen shot of a user interface presented after the diagnosis is declared and lists the differential diagnoses, resuscitation steps, potentially harmful treatments and the most effective treatment algorithm.

### DETAILED DESCRIPTION OF THE INVENTION

The present invention provides for an expert medical decision support system including both methods and systems. When describing the present invention, all terms not defined herein have their common art-recognized meanings.

As used herein, an “adverse medical event” shall mean an event which arises from a human error or equipment failure or which arises spontaneously or as a result of a patient's disease or injury, which would likely lead (if not discovered and treated on a timely basis) or did lead to an undesirable outcome, which may range from minor consequences to death. An adverse medical event may be a critical event resulting in a crisis situation or a non-critical event. A difference between critical and non-critical events is the length of time during which effective treatment can begin in order to correct the situation.

As used herein, a “hospital information system” or “information system” or “IS” shall mean a computer based system used to collect, store, manage, organize, and present information relevant to hospitals, physicians and hospital staff and patients. It may contain information including patient data, medical equipment, medications, medical insurance company coverage, hospital supplies and drug inventory. It may have specific hardware and software used for patient care, including vital sign monitoring. These systems will generally be linked via local and wide area networks and will include any system that will provide digital input to the DT and/or OA expert systems.

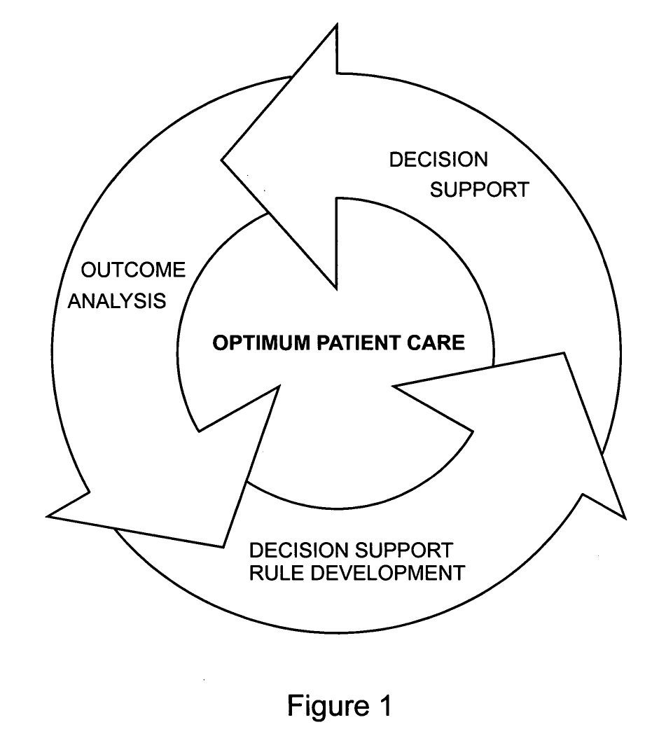

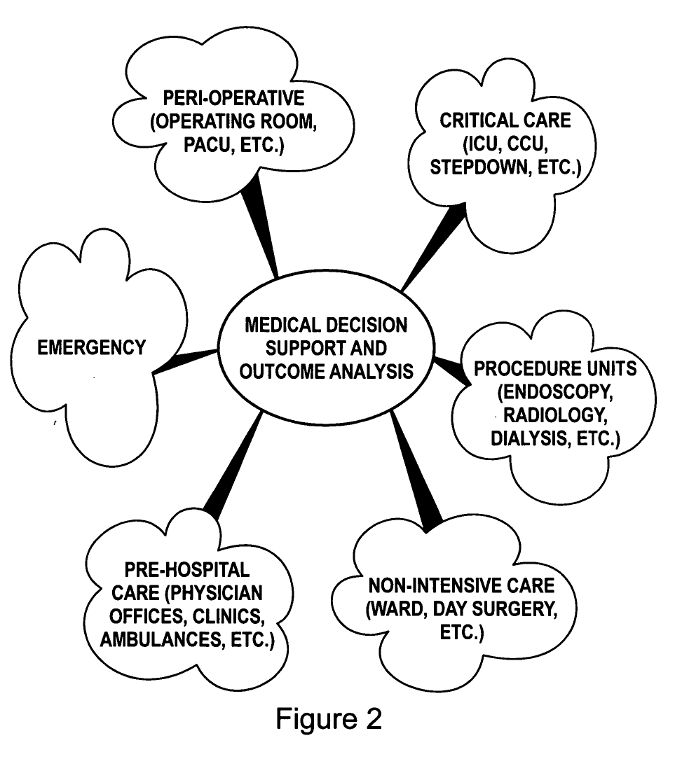

As shown in FIG. 1, optimum patient care may be achieved by providing decision support with the present invention, performing outcome analysis and using outcome analysis to further develop the decision support rules. This model may be applied to any medical discipline, including those shown in FIG. 2. Examples may include, without limitation, peri-operative areas (anesthesia, Operating room, Post Anesthesia Care Unit), critical care (Intensive Care Unit, Coronary Care Unit, Step-down Unit), procedure units (Radiology, Endoscopy, Laboratory), non-intensive care (Ward, Day Surgery), and emergency medicine. It may occur in different institutions including hospitals, outpatient clinics, physician's offices and pre-hospital emergency care.

The first task in development of the present invention is the development of comprehensive, legitimate, effective diagnosis and treatment (DT) rules. As these rules are intended to govern the decision support making capability, they must be medically legitimate and widely accepted. If accepted medical knowledge provides alternative paths which each have proponents and detractors, then such alternatives must both be provided for within the DT rules. The DT rules will, in one embodiment, be prepared by an expert committee, which adopts and adheres to clearly defined processes for establishing the rules. Of course, the committee members must be capable individuals who have a reputation for excellence in the diagnosis and care of patients in crisis. Ideally, they would have a national or possibly international reputation for providing evidence based clinical care and research. Combined, they would have extensive clinical experience with managing these patients of all age groups. They would have skills doing critical appraisal of medical literature and development of clinical practice guidelines. Although there are many clinicians that would make valuable contributions to the committee, the size of the committee will be limited to ensure that the group will function productively and develop the highest quality rules in a reasonable period of time.

The breadth, comprehensiveness and accuracy of the rules are features of preferred embodiments of the present invention. However, it is not intended to limit basic configurations. The present invention may comprise systems where only a limited rule set is implemented. In such cases, the committee may comprise a single user.

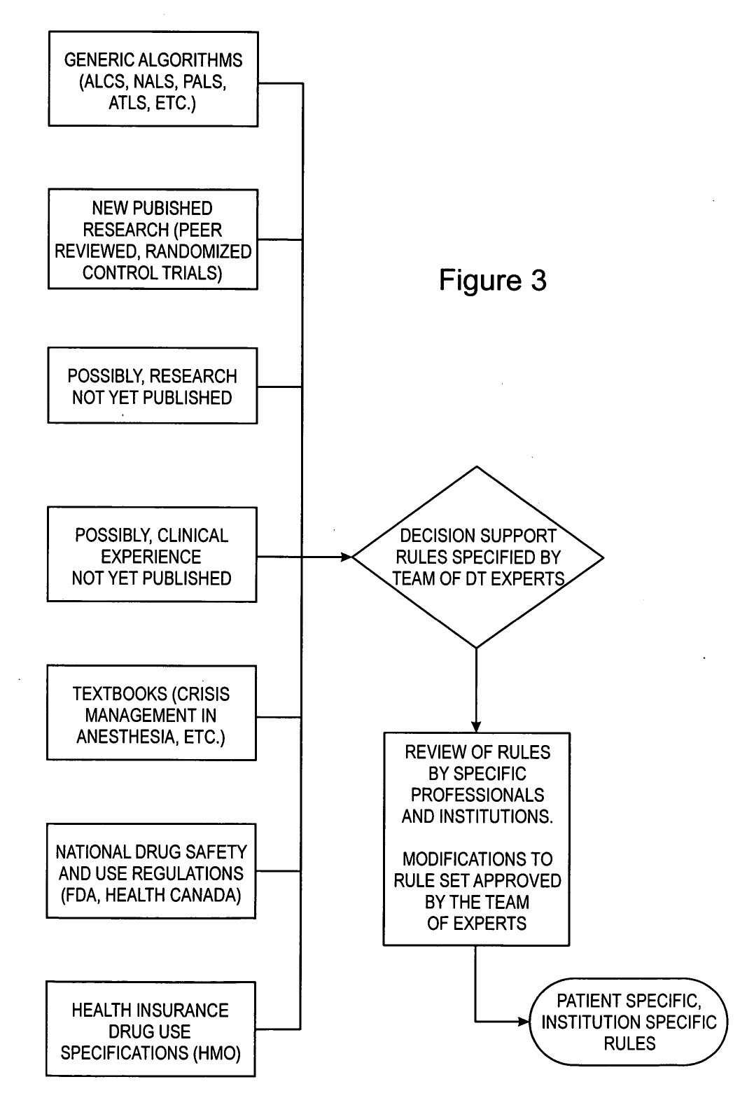

The committee may decide which pieces of medical evidence will be used to define the rules. Specific criteria may be established to define clearly whether a source is acceptable for use by the Committee. Only those sources that meet the criteria will be used. Peer reviewed, widely accepted clinical practice guidelines developed by experts through a critical appraisal of medical literature, such as the ACLS guidelines, will become the key foundation for rule development. However, other sources that meet the inclusion criteria may be used, as shown in FIG. 3. These may include published and unpublished research.

It is expected that the expert committee may have to be in contact with other international expert committees or have some committee members in common. With strong communication between the various groups of experts, upcoming changes to widely accepted practice guidelines and new medical research could be quickly reflected in the DT rule set. Clinical practice guidelines and the rule set are meant to be complementary since they both share the common goal of providing the best possible care for patients. It is expected that this cooperation would extend across the varied medical disciplines and international borders.

The expert committee may examine the evidence and benefit for each possible diagnosis, resuscitation and treatment. It is expected that as the expert committee examines the same sources, they will achieve a consensus opinion on each rule. The evidence for establishment of each rule such as the key reference journal articles will be documented for use by the committee during later rule modification. In addition, the benefit for each treatment step may also be established.

If consensus is not obtained, the strength of the dissent may cause the committee to include or exclude the rule from the rule set. If any dissent exists and the rule is included, an indication may be given to the user that dissent exists and the strength of the dissent.

The rule set may undergo further modifications. For example, it may be modified for each country to adjust for national variances. These modifications might include medication names changes or complete exclusion of medications based on availability or regulatory approvals. These rule set changes may be done by the DT expert committee or possibly by another subset of experts qualified to do the task.

The DT expert committee will define which patient data is necessary to effectively diagnose, resuscitate and treat the patient. The committee will determine the type of data that must be collected and for time stamped data, the duration that must be included. For example, the Committee may define that heart rate is important for collection during a crisis and it will decide whether the rules require the last recorded heart rate or the data over the past ten minutes or some other time period.

Naming of procedures and diseases is preferably consistent with the ICD-10 definitions. Other data dictionary names may be consistent with the SNOMED dictionary of medical terms.

It is preferred that the rules be written in plain English. This enables medical experts who do not have computer programming expertise to easily develop and change rules. Rules can be defined for every possible situation such as occurring in different locations (ICU, Operating Room, Radiology etc) and for each possible patient problem including those related to medical history, medications, allergies, current surgical or medical procedure so that application of these rules would generate results customized for the particular situation. The rules define decision support information customized for each patient.

Defining a single set of rules that cover a multitude of situations and storing these rules at one site makes finding and using them easier than if they were stored at multiple locations. Rules can be modified for needs of specific countries that may each have different medication names and approval for use. Rules can be modified for each institution to meet their unique needs. A library of all rule sets can be maintained at the central site and the necessary rules dispensed to the systems running at each location.

The rules may be organized in any logical manner. For example, rule sets may be used to categorize and organize diagnostic rules based on the type and stage of medical treatment such as pre-operative care, intra-operative care, and post-operative care. As well, the rule sets may diverge with respect to patient information, such as the age and sex of the patient.

The expert committee will establish a basic rule set for a particular crisis within each group that will assist in the diagnosis, resuscitation and treatment of the patient. The basic rule set may be tested using an input data set containing sample parameters where there are no extenuating circumstances. Assuming that this generic patient is otherwise healthy, has no allergies, medications, no procedures and is in a particular clinical location. With this rule set well established, it may then be modified to account for patients that vary from the uncomplicated generic patient. Additional test case input data sets may be created to test the rules that are designed to handle patient scenarios that include “unusual” or “abnormal” conditions. These conditions include patient medications, allergies, procedures, current patient location and current patient status. The test input data sets designed to manage anomalous conditions may necessarily each include many potential problems. In practice, the data generated in any real patient situation will at most include a subset of the anomalous conditions. The test input data sets must be carefully designed to cover the various combinations and permutations of possible situations. As a result, there may be specific rules to clearly design the optimum approach for the diagnosis and treatment of each particular patient.

The DT rules would identify the list of possible diagnoses for this particular patient. Preferably, diagnoses that are particular for this patient's medical problems and current procedures being done are identified and displayed. For example, a patient with hypotension that is currently undergoing a hip arthroplasty might be diagnosed with a pulmonary embolus. By examining the many factors of each patient, a comprehensive diagnosis list will be generated by the rule set.

By examining the current status of the patient, such as the oxygen saturation or pulse rate, the rules can suggest those diagnoses that might be of higher probability. For example, the patient with hypotension might also be developing hypoxia (low oxygen saturation). The DT rule set identifies higher probability diagnoses as those that are consistent not only with hypotension but also with the rest of the patient's status including hypoxia. With the consideration that the patient's status includes many variables, the rule set will identify those highest probability diagnoses that are consistent with the patient's current status. Accordingly, in a preferred embodiment, the DT rules not only generate the list of possible diagnoses for this particular patient but also identifies the higher probability diagnoses from within it. These diagnoses could be listed in order of most life-threatening diagnoses to least serious diagnoses.

The DT rules may list resuscitation alternatives for the patient. It will consider the patient's status to decide which alternatives would be beneficial and determine the most likely dose and route. For example, the resuscitation of a hypotensive patient may vary based on the patient's heart rate. For a heart rate less than 60 bpm, Ephedrine™ 10 mg IV might be more appropriate than using another anti-hypotension medication such as Phenylephrine™ 100 mcg IV. In addition, the rules will consider other factors such as the patient's medical problems, allergies, age and weight to provide resuscitation decision support customized to the patient.

To provide the best quality decision support, the DT rules may examine the current management of the patient. For example, the DT rules may recognize that a hypoxic (low oxygen saturation) patient is only receiving 40% oxygen. It will recognize this problem and suggest that the patient's oxygen delivery be increased to 100% to increase the patient's oxygen saturation.

The DT rules may generate a list of the most effective treatment alternatives that have been customized for the particular patient. It will consider all the patient factors and generate a list of prioritized treatment alternatives.

A standard reporting system of treatment efficacy will be determined by the Expert Committee. The Committee may decide to use a system such as the Class of Recommendation approach as used in the ACLS guidelines. The DT rules will provide the likely efficacy of treatment steps according to the defined system.

The rules may recommend other investigations such as laboratory work or procedures such as a central line insertion to better manage or identify possible complications.

In addition, the rules may develop a list of treatments that are frequently used for management of the disease but might be potentially harmful for this particular patient. This data will be sent to the hospital IS. The IS will ensure that when harmful treatments are listed, they will be appropriately identified as harmful so that they will not be confused with possible treatment alternatives.

In a critical situation, as defined above, the Diagnosis and Treatment (DT) expert system module will provide decision support for the diagnosis and resuscitation of a patient by the user. In order to do so, all information relevant to the critical situation must be provided to the system. After processing the data and applying the DT rules, an extensive list of all possible differential diagnoses customized for this particular patient is generated. The most probable diagnoses on this list are also identified. The diagnoses may be arranged in a logical manner such as listing the life-threatening and most probable diagnoses first. The list of possible diagnoses will be customized to the particular patient and the particular procedure, if any, being undertaken at the time of the crisis.

Additionally and concurrently, the DT module will generate a prioritized list of appropriate steps for resuscitating this particular patient. Resuscitation is frequently essential for keeping the patient alive at least long enough for the user to make the diagnosis and start the most effective definitive treatment. The diagnostic and resuscitative results generated by the system are transmitted back to the hospital IS for display and possible use for the establishment of an efficient method for user data entry

Even if the user does not need the decision support to make the diagnosis, the user may benefit from using an efficient user entry format to document the diagnosis. By providing the list of diagnoses and possible resuscitation steps to the HIS, the expert system may enable the hospital IS to provide an efficient user entry interface for documenting the diagnosis and the steps taken to treat the patient.

One skilled in the art will recognize that the ability of the DT module to provide useful customized information to a treating professional will be dependent upon accurate and timely provision of relevant data to the DT module. Non-physiological data such as the patient's age, sex, weight may be entered into the system when the patient is admitted to the hospital or may already be present in the system if the patient has been previously admitted or treated at the hospital. Other information such as the medications being taken by the patient and any known allergies may be entered at other relevant times. The system may access medical libraries including medication names, doses and contraindications. Lastly, a preferred embodiment of the present invention contemplates the collection and transmission of physiological data in real-time, such as the patient's heart rate, blood pressure and oxygen saturation. The instrumentation and sensors necessary to collect and transmit such data are well-known and commercially available.

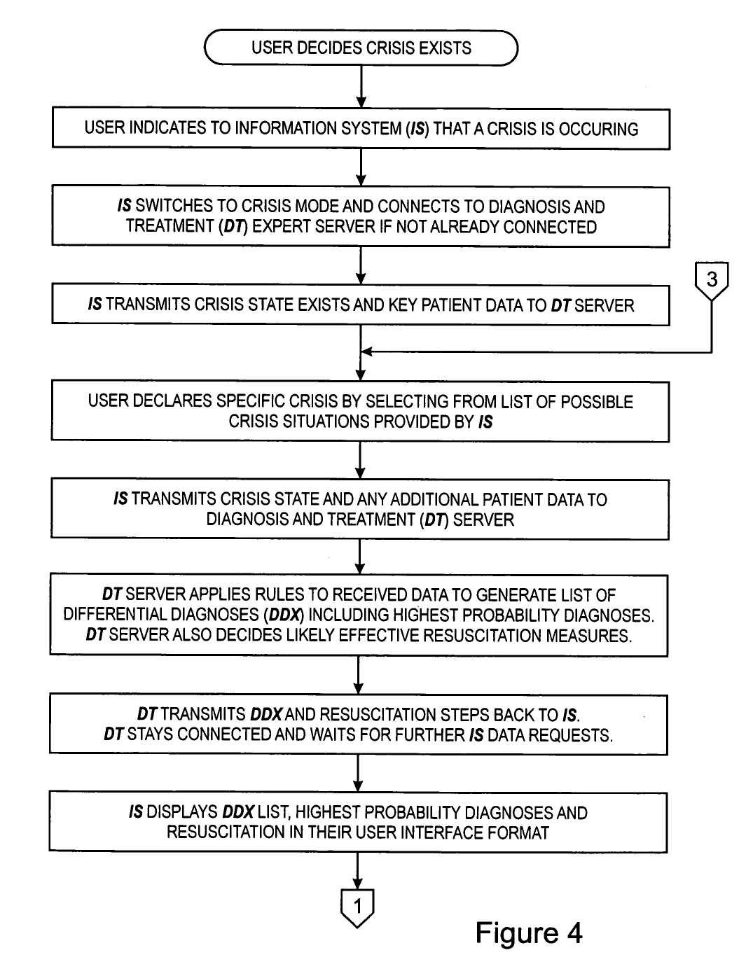

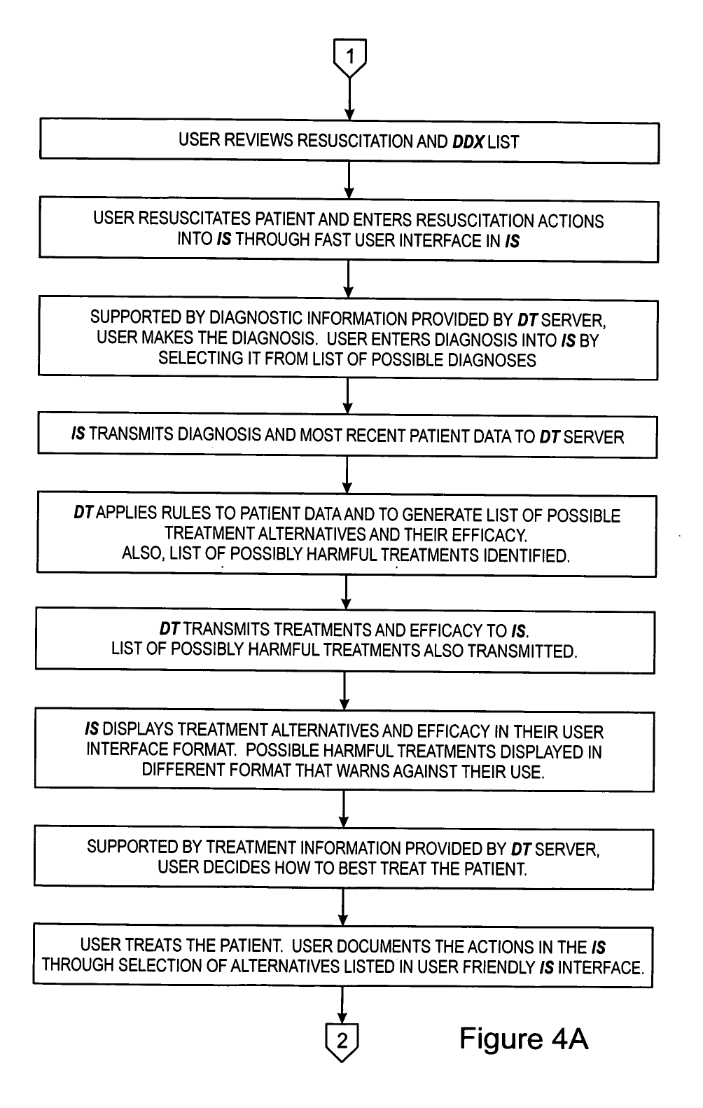

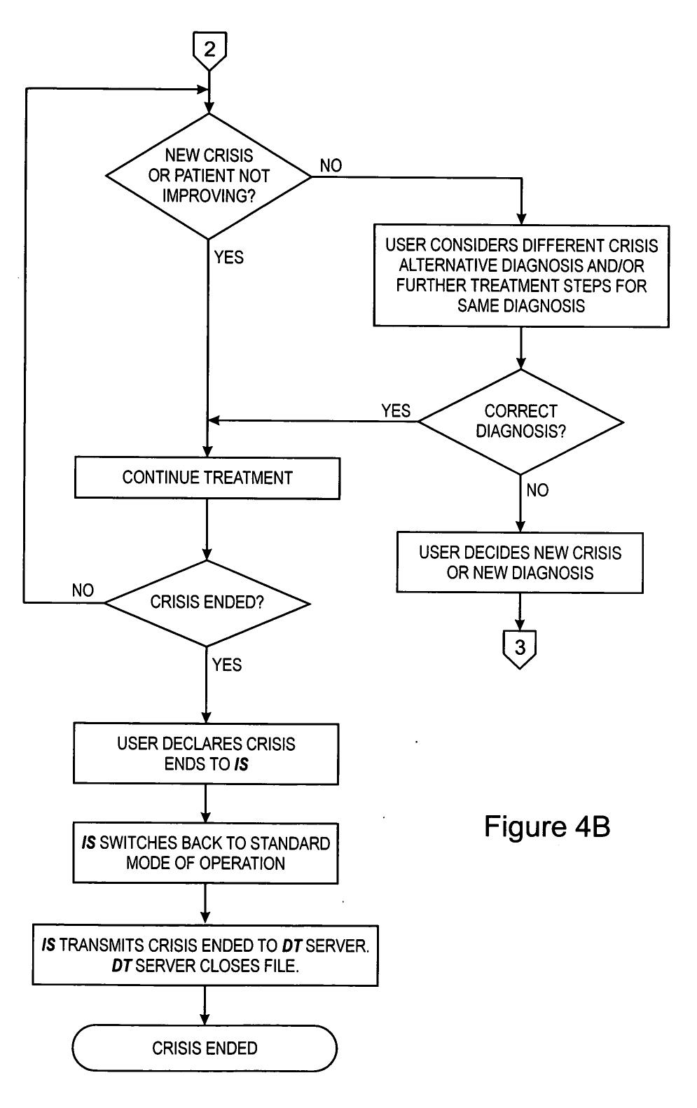

In one embodiment, and with reference to FIGS. 4A-C, the method is initiated upon a user deciding that they need decision support. The user may then either activate a decision support button on the IS screen or through some other mechanism, which indicates to the hospital IS that their patient is experiencing an adverse medical event, which may either be a critical or non-critical event. The IS responds to the alarm state by providing a list of possible problems that may be occurring. The user may then choose the problem from the list of possibilities provided by the hospital information system. Alternatively, the list of possible problems may be provided by the DT server and communicated to the IS. The IS will then connect to the DT server at either a local or remote server site, if not already connected. It will request DT expert system decision support from the DT server. The DT module then generates a random identification number and transmits it to the IS to establish a common identifier for future communications. With the identification number, the IS then transmits the most recent patient information including the key data from a specified time period until the current time. This time period may have been pre-defined by a DT expert committee and will likely vary for particular problems or situations. Data transmitted from the IS to the DT module will include patient age, weight, allergies, medications, medical history, surgical history, procedure history and current patient parameters including vital signs. In one embodiment, the date, patient's name, care giver's name, institution name, patient birth date and other specific identifiers will not be sent from the institution to the DT module. Accordingly, no data will be sent to the DT module that might be considered confidential so that patient and hospital information privacy concerns will be met. If the DT server is local to the IS, confidentiality may not be a concern.

The DT module will keep a log of data provided by the information system and the user support given back by the module. This log may be audited for trouble shooting and quality improvement purposes. The list of fields kept in the log will include any and all fields that the DT module may use to make a determination. The data will preferably be stored in an encrypted format, with no standard query available to the user to be able to extract the raw data. In the case of a medical emergency, or a situation where there is a legal mandate, the differential diagnosis and treatment support that the system generated at some point in the past for a particular case may be reconstructed and retrieved from the data log.

With the data received by the DT module, the appropriate DT rules will be identified for use. The rules will be applied to the data to generate a list of all possible diagnoses and the most probable diagnoses. Rules will be applied to the data to generate a list of most useful resuscitation alternatives that can be done to help the patient while the user is spending time to diagnose the particular problem. The module will transmit the results of the analysis to include the possible diagnoses, the most probable diagnoses, and resuscitation alternatives back to the IS. The hospital IS will display the user support data in a productive manner for the user. In addition, the IS may use this information to develop a user friendly efficient method for the user to eventually choose the diagnosis and rapidly enter resuscitation steps as they are completed. This method for display and user entry may vary considerably between different manufacturers of the hospital information systems.

In one embodiment, the user interface for information display and data entry may comprise the use of browser program and HTML coding, using hyperlinks and associated features. In a preferred embodiment, the workstation comprising the user interface may include a touch-sensitive screen to display Active Server Pages (ASP) user interface pages.

In a preferred embodiment, the DT module will then provide treatment alternatives and warn against possible harmful alternatives. DT rules are applied to identify possible treatment alternatives and may preferably indicate how beneficial each treatment step might be as well as its likelihood of success. It may also identify which treatment alternatives might be potentially harmful for this patient

Accordingly, the user is provided the most up to date recommendations for treating their particular patient. Additionally, data entry is potentially made easier by identifying to the information system what treatment alternatives the user is most likely to use and thereby gives the system the opportunity for a custom single stroke key definition to enter an action.

Listing possible treatment alternatives on a computer screen gives not only the user but also other team members information on what treatment steps may be carried out next. As a result, the entire team can anticipate the upcoming treatment step(s) and have the necessary equipment or medications available if and when it is needed.

With the communication from the information system to the DT server still intact, the information system will transmit the diagnosis that the user has made back to the DT module. In addition, all new patient data that has accumulated since the last transmission will also be sent to the DT module. With the DT rules, the DT module will generate a list of the most effective treatment alternatives for this particular patient. Each treatment alternative may also have an indication of how effective this treatment might be for this individual. A standardized system for reporting efficacy may be used. The rules may also identify which treatment alternatives might be harmful for this patient. The harmful alternatives will be actions that might otherwise be beneficial to patients with the same problem but are harmful for this particular patient. The DT module will transmit the treatment alternatives and their respective likely efficacy and possible harmful treatments to the IS. The IS will route the information to a workstation such that users can identify and record specific treatment actions. In addition, the information system can display in a different format those actions that might be potentially harmful to the patient.

One skilled in the medical art will recognize that diagnosis, resuscitation and treatment choices and actions may occur sequentially or concurrently. In its preferred embodiment, the system will be capable of responding in either a sequential or concurrent manner.

The user may then choose the most appropriate treatment alternative presented by the DT server and treat the patient accordingly. As well, in a preferred embodiment, the user may document the actions taken during treatment by interacting with the interface, and a record of such actions may be transmitted to the DT server and recorded. If the patient improves to a point where the user may consider the adverse event to have ended, the user declares that the event has ended to the IS which transmits that signal back to the DT server. The DT server may then close the individual crisis file opened for that crisis.

In the event the user decides there is a new problem, the method may be repeated with the new problem situation. Furthermore, if the patient fails to improve, the user may consider an alternative diagnosis, or alternative resuscitation steps or an alternative treatment.

Outcome Analysis Expert System Module

It is the goal of outcome analysis (OA) to analyze relevant data on a routine basis to identify and report possible problems and to provide information which may be used to improve the DT rules to minimize adverse outcomes and maximize positive outcomes. The OA analysis will have greater utility with broader use and acceptance. Universal acceptance prevents duplication of efforts as each specialty in each country repeats the process of developing and maintaining an OA database and analysis tools.

In a basic embodiment, the outcome analysis module simply functions to collect and analyze data which may be used to confirm or modify existing DT rules. The breadth of outcome analysis is linked to the breadth of the DT rules which exist in the system. In simpler or more basic implementations, outcome analysis may be undertaken by a single user. In preferred complex implementations, a first step may be to form an OA Expert committee. The committee may be compromised of experts who have reputations for excellence in quality assurance and outcome analysis. Preferably, some members may have skills in research and statistics. The committee may include representatives from different local, national or international organizations that record and report critical and adverse events. Similar to the DT expert committee, the OA committee will have limited size and benefit from excellent communication with other outcome analysis organizations.

As a starting point for their work, the Committee may examine what event data is collected and analysis done by existing outcome analysis groups. The Committee will identify all of the national and international outcome analysis groups. For example, physicians that practice Anesthesia have formed their own national groups that request and receive reports on critical events managed by Anesthesia practitioners. The OA expert committee will examine what data is collected and what analysis is done by each national group. When this is done for the many different specialties in the different countries, the OA Committee will have a clear understanding of the current state of outcome analysis. This will likely form the minimum requirements for data collection and analysis.

Using the current state of outcome analysis and in consultation with the various national organizations, the OA expert committee will define what would be the optimum outcome analysis. Specifically, they will define what clinical questions require answering for each adverse and critical event and identify what reporting of results would be required. When the questions are clearly defined as rules, the committee can work backward to then define what data must be collected to provide sufficient detail for completion of the analysis.

The OA expert committee may write rules to determine which data must be collected from each adverse event and to determine mandatory analysis and reporting of the critical and adverse events. The rules may also determine which individuals will have access to the database to do custom database analysis.

In addition, communication of common goals between the OA expert committee and the national groups will ensure that both work in a cooperative manner sharing information that will improve the quality of patient care.

The OA database may contain the patient information (non-identifying) for cases of adverse critical or non-critical events, which have been handled by the DT module. The OA module receives and maintains a confidential centralized database of adverse events. The OA database will therefore contain a centralized source for all events that occur in the many hospital environments such as the Intensive Care Unit and the Operating Room. In addition, the OA databases may be a centralized source that stores the events that occur across the many institutions in one country or across many different countries.

The OA module provides tools and access for authorized researchers to analyze data and look for solutions while confidentiality of data is maintained. Analysis and results would be obtained without identification of individual hospitals, care providers or patients.

The single centralized database will reduce work necessary by researchers to find and access outcome data. The researchers would have access to the largest data pool with data extending beyond the borders of institutions, medical specialties and national boundaries. Having one data pool will enable researchers to spot trends or problems sooner than waiting for a critical number of cases to occur in a single institution, country or specialty. Since adverse events and crisis situations occur with reduced frequency, looking for the events occurring in many locations will reduce the time needed for minimum threshold numbers to occur that would generate the outcome analysis research necessary to identify if a problem exists. As a result, solutions that will improve patient care can be found sooner. Researchers can work to improve quality of care across different medical specialties, types of institutions, types of health care providers and geographic borders. A single OA database used by different specialties across different countries reduces the cost of each setting up and maintaining their own individual database. Without identifiable features in the patient data, there would be no risk of confidentiality breaches by the researchers. Researchers can focus on doing timely outcome analysis research on this database instead of spending considerable time and money ensuring that they meet the legal requirements to do research on a database that may contain confidential patient information.

Since a critical event may involve a prior communication between the hospital IS and the DT module, the DT module may log information such as the time and date that may in some way help to identify a patient or institution. As a result, there would be no access to the DT module by OA researchers. The researchers would have access to only the OA database. Access may be managed by password controlled logins which have specified permissions, as is well-known in the art.

The structure of the OA database is determined through the application of the OA analysis rules that define what data is to be collected for each event and its form. The database is preferably structured so that it is efficient in terms of space needed to store the data and access it with sophisticated well-known data mining tools.

The OA rules serve as tools for individual researchers but may be modified for custom research and analysis. The OA module may generate automated reports of crisis to individual hospitals or to specified individual users. Individual users will be made aware of patient problems that have occurred so that they might avoid a similar problem during their own patient care. OA analysis results may be provided to OA committee for further analysis and publication. OA analysis results may be provided to the DT expert committee for use in revising DT rules.

This provides a redundant level of reporting for problems that may be missed by any single hospital information system. Reporting on issues that have occurred at other institutions might enable the institution to make the necessary systemic changes to avoid an occurrence at their site.

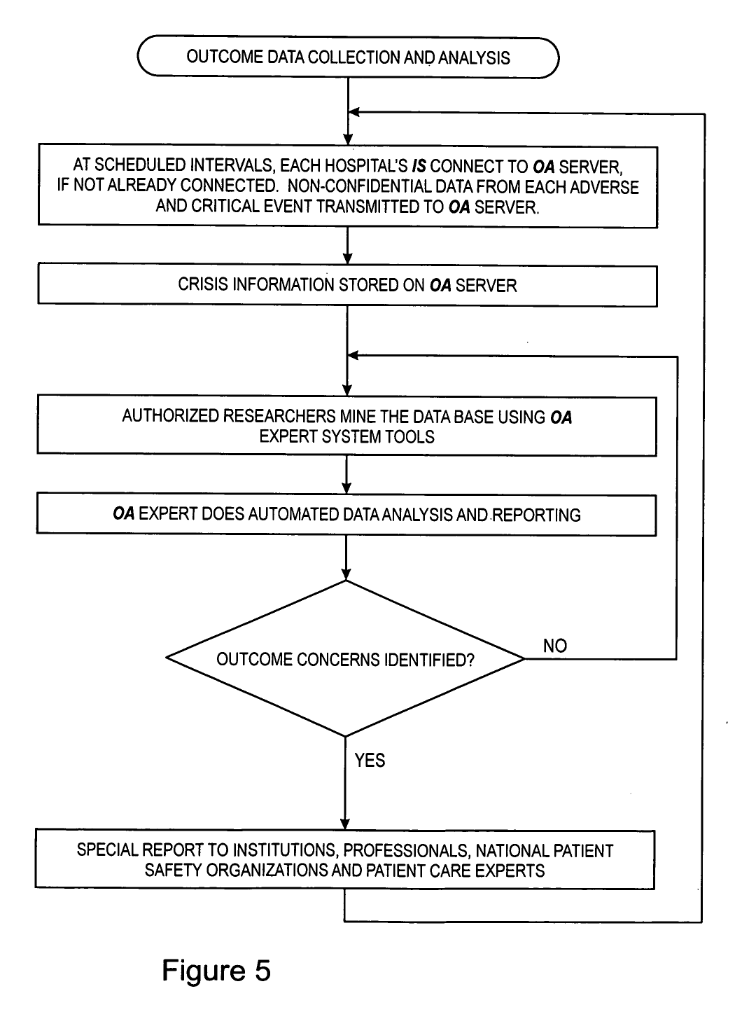

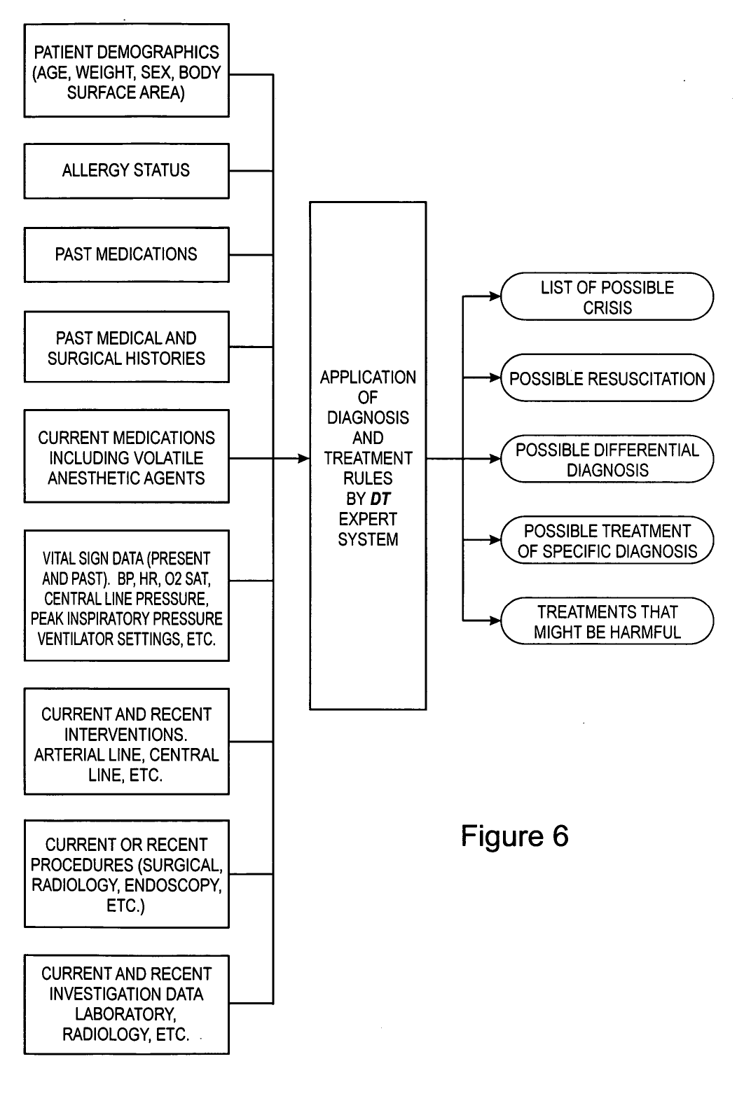

With reference to FIG. 5, each institution's hospital IS will connect with the OA server preferably on a regularly scheduled interval. The IS may then transfer specific information on each critical and adverse event that the IS has recorded since the previous transfer. The transferred information will include the data defined by the OA rules. However, no data will be transferred that can identify the institution, the patient or the care giver. However, it may include non-identifying information such as the patient's age, the type of care giver (physician, resident, intern, nurse etc). Specific data from the event will be defined by the rules and it is expected to include data from the event itself and data from a specified time period before and after the event. In addition, the OA rules may define that other information such as complications that may occur even days after the event will also be downloaded to the OA server.

In a preferred embodiment, the OA rules may provide that the hospital IS also transfer the total quantities of similar patients that the institution has treated since the last download so that statistical analysis such as incidence of events can be calculated. The connection between the IS and the OA server will be scheduled to occur at times of low usage of the IS and OA server so that data transfer tasks will cause the least interference with optimal IS and OA server performance. OA rules will define automated reports that are to be generated by the OA module. It is likely that the rules will define reports to calculate the incidence and monitor the trends of the specific adverse and critical events. Automated reports of the analysis will be distributed to the OA expert committee and other authorized parties. The purpose of this distribution will be to alert and inform these individuals to events that require further analysis and possibly develop mechanisms to improve patient care.

Individual users and national reporting agencies will receive the automated reports that concern their scope of practice. OA experts might identify key cases that reveal practice patterns that could be improved. As a result, they might transfer a key summary of an individual case or group of cases to practitioners as part of an educational session with the goal of preventing a repetition of these events by other practitioners.

In the event, an outcome concern is identified, a special or custom report may be generated and transmitted to those entities connected to the OA system. Measurement and analysis of outcomes will likely lead to improvement in the management of patients through changes in the practice guidelines. These changes will be adopted through modification of the DT rules changes by DT experts. The revisions and rationale are communicated to users and OA experts.

As a result, an adaptive feedback loop is established where practice guidelines are standardized through definition of the DT rules. Implementation of these rules will support decisions made by users managing critical events. Measuring outcomes as a result of the rules and analyzing for possible outcome improvements may provide the research necessary to improve patient care guidelines and eventually the DT rules.

Through analysis of events that have been identified through automated reporting or through customized research, practice patterns that might contribute to reduced patient outcome can be established. Although this data may also be published in journals, the analysis data can be sent directly to the OA expert committee, the DT expert committee, other outcome analysis researchers and committees that establish practice guidelines.

After rigorous assessment of the data to ensure that it meets acceptability criteria, the researchers may agree that a change in practice patterns is needed or possibly, begin additional research to answer remaining clinical questions.

When any change in practice patterns is recommended, these changes can be given to the DT Expert committee for analysis. After ensuring that there is sufficient evidence to support the change, the appropriate DT expert rules will be modified to reflect these new standards. This architecture constitutes a feedback loop where DT decision support and ultimately, patient care is improved. The OA system monitors the outcome of patients and the effectiveness of the DT rules. As a result of OA system analysis complimented by other research and analysis, changes in practice patterns for the diagnosis and management of patients may become necessary. The DT module will be modified to reflect these changes. As a result of setting standard patient care practice guidelines and analyzing the outcomes, deficiencies in patient care can be identified and improved.

The upgraded DT rules should preferably be tested before revising the existing DT rules set on the DT server. The necessary hardware and software configuration will be in place to ensure that a single DT server can undergo a software upgrade over the network while another server is available to service the needs of users. The entire system should not experience downtime while individual servers are undergoing software upgrades.

Software

The software necessary to design and implement the present invention is either commercially available or is within the ordinary skill of those skilled in the art to create. Any specific identification of a software product or feature is not intended to limit the claimed invention.

It is preferred that the present invention be implemented with widely implemented operating systems such as Windows XP Professional™ or Windows 2003 Server™ Operating System or both. These are stable operating systems that are industry standard and compatible with existing hospital information systems and systems that may be installed in the foreseeable future. Of course, those skilled in the art may use alternative operating systems such as Linux-based systems.

Using an industry standard operating system maximizes the likelihood that the application will be compatible with the target platform without requiring costly and difficult to maintain customization.

Windows™ operating systems may include the Microsoft .NET Framework software, which allows developers to create applications that can take advantage of the Internet to access applications that are running remotely on application servers, while maintaining a user interface that is familiar to users of Microsoft Windows based applications.

In a preferred embodiment, the modules of the present invention may use Extensible Markup Language (XML) to communicate with the hospital information system applications. Taking advantage of this standard protocol will minimize work required by the developers of hospital information systems to setup the interface required to utilize the services of the expert system of the present invention.

The use of Windows Server 2003 allows applications running locally on Windows XP (or Windows 2000 with the .NET Framework installed) to access and run programs setup as Web Services via the Internet.

Rule Based Expert System

Rule-based expert system development tools are commercially available and include Expert System Creator™ and Expert System Designer™ by Optimal Solution Software, Blaze Expert™ by Fair Isaac Corp. and Microsoft Visual Rules Expert System™. The latter product is a reliable customizable powerful expert system development tool. The Visual Rule Studio™ inference engine is built on a mature design that has been updated over time to utilize the latest available software technology. The inference process is fast, reliable, and has been used in production environments for over 20 years. The language used to define the rules is called PRL, and has evolved to become an efficient tool for defining and storing complex inter-related rules in distinct rule sets.

Such a system is customizable to a hospital IS and utilizes fuzzy logic so that hard thresholds do not necessarily exist. For example, treatment recommendations for a 29 day old patient may vary with a 33 day old if there was a hard limit of 1 month but fuzzy logic may smooth out the treatment alternative recommendation.

The Visual Rule Studio inference engine processes the PRL and uses backward chaining, forward chaining or a combination of both to find a solution, as is well known in the art. PRL can be used to create rules that use “fuzzy logic” giving the expert system the flexibility to deal with non-precise data using modifiers such as “very” or “slightly” as well as unknown or missing values.

The expert system application data connectivity code may be written using Microsoft Visual Basic .NET™ and Rule Machines Visual Rule Studio or similar products, which are software tools used to access external databases and define the diagnostic rules and include the inference engine that performs the backward and forward chaining to infer a solution. Visual Rule Studio also isolates the rules from the data connectivity and presentation layer code. The rules are organized within rule sets based on logical categories. Test rule sets are used to allow offline testing of rules before they are moved to the production rule sets. These features make the process of defining, validating and maintaining the rules much simpler and less prone to error.

Visual Rule Studio software may either store the rules in a proprietary repository or store the rules within an external database.

In use, the user will initiate a diagnostic transaction from within the hospital information system, which will transmit the known input parameters to the web service using XML. The expert system will use the known parameters to initiate the inference process and perform the diagnosis. The rule sets will be designed to use forward and backward chaining as required to infer the values of missing attributes and to generate the output data stream.

Fuzzy logic techniques will be used to handle qualifiers added to input attributes in order to use the language that a caregiver might use to describe a particular condition. For example, a patient may be described as “slightly” jaundiced as apposed to “moderately” or “highly” jaundiced.

Once a solution has been found, the results will be transmitted back to the hospital information system via XML. The hospital information system developers will incorporate the result in their graphical user interface so that it can be presented seamlessly within their applications and on their monitors.

Both the DT and OA modules are preferably designed as a web service allowing it to be used by any hospital via the Internet. The expert system will communicate with hospital information systems via a pre-defined XML interface and do not have any ad-hoc query capability. The input and output attributes are named based on industry standard naming conventions.

The DT and OA systems should preferably be run on separate servers. The OA system may have a user interface that will allow users to generate prepared reports based on user specified screening conditions. Preferably, the OA module will have the ability to perform ad-hoc queries. Ad-hoc queries will be parsed and analyzed before being run in order to avoid system performance issues and to prevent mal-formed queries from allowing potential attackers from gaining access to the server or otherwise causing damage to the system.

Hardware, Network, Communications and Security

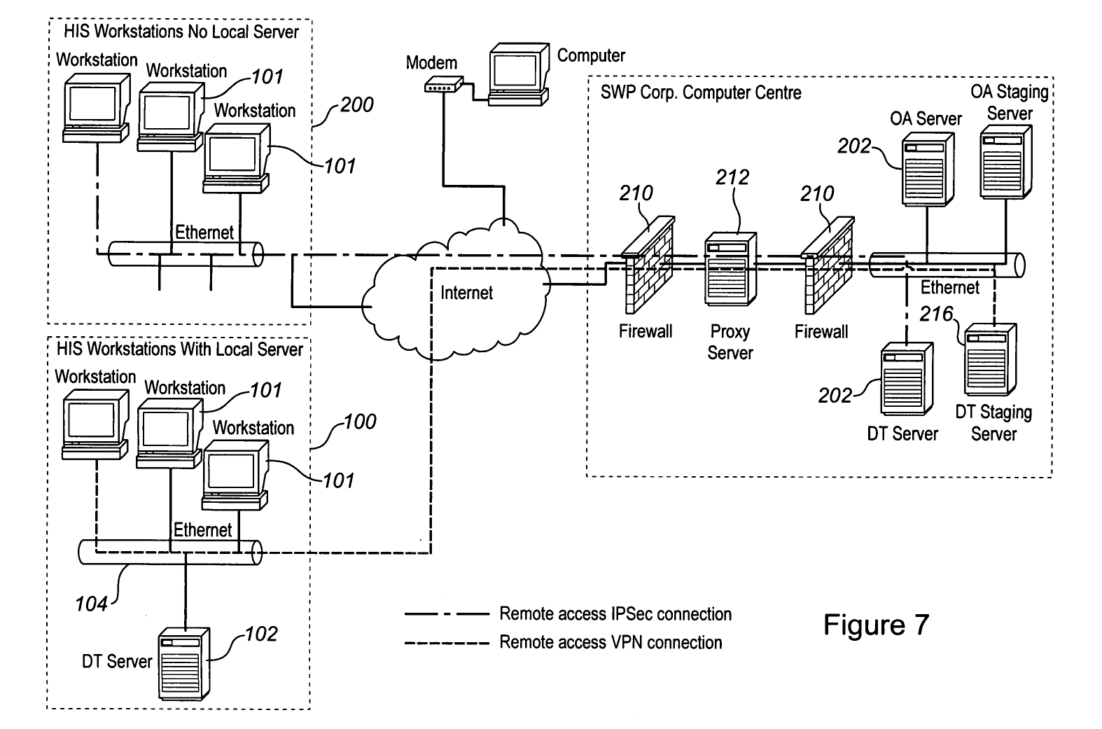

As shown in FIG. 7, the present invention may include embodiments running on local or remote servers providing a “web-service” that the hospital information systems can use to help diagnose a problem based on current and historical values of a plurality of parameters. These parameters contain data that is generated by the hardware that is used to monitor the health of the patient as well as data that is manually selected and/or entered by the caregiver. Each hospital IS (100) also includes a plurality of workstations (101). Workstations can include devices capable of web server access such as personal computers, wired or wireless laptop or tablet computers, personal digital assistants with wireless access, smart phones, dumb terminals and patient monitors. If the hospital IS (100) has a local DT server (102), it may be connected by a network (104) such as an Ethernet or token-ring network. If the hospital IS (200) does not have a local DT server, it may have connectivity through the Internet to a remote DT server (202).

It is preferred to provide high speed analysis of data provided by the information system and transmission of DT decision support information to the user in the shortest possible time. Accordingly, the expert system inference engine should preferably run on a dedicated application server with a large amount of memory and redundant high-speed mirrored disk drives. The application server will access a separate database server via a high-speed switch to process database queries. The inference engine can process thousands of rules per second and is rarely the bottleneck in performance benchmarks. In one embodiment, the web service receives text based XML data as its input and generates text based XML data as its output. As a result, minimum time is required to request and receive diagnosis and treatment decision support information.

The actual volume of information being transmitted between the hospital information system and the expert system is relatively small and the transmission time on a high-speed connection will be negligible.

The hardware configuration should preferably include redundancies and backup strategies which are well known in the art.

The expert system and the database that will store the input data are separated from the Internet by two firewalls (210) which may include hardware and software firewalls. A safety zone (DMZ) between the two firewalls may house proxy servers (212), which will respond to requests from the Internet and forward the necessary information to the application servers on the internal LAN (214). All personal information in the input data will be encrypted and potentially obfuscated to prevent illegal access. A log of the diagnostic transactions will be stored in a history table. If an Internet enabled version of Visual Rule Studio is utilized, it will be possible to recreate a result that was generated at a particular point in the past. This will be possible because of activation and expiration dates on the rules.

In one embodiment, both the DT module and the OA module will be running on application servers (202) residing in a server farm, such as a Citrix™ server farm. This provides reliability through redundancy as well as scalability and also makes it possible to perform maintenance on individual servers without creating downtime.

In a preferred embodiment, as the diagnostic rules are updated and the rule sets are enhanced, both the DT and OA modules will be migrated from a development platform (not shown) to a staging platform (216). The staging platform hardware and software will be identical to the production platform (202). Only after the expert system has been tested using the benchmark input data sets and certified by a team of analysts exclusive of the development team, will it be promoted to the production platform (202) and accessed by system users.

The DT rules will be stored in a central repository to ensure that all diagnosis and treatment transactions in session at any one point in time will be using the same production rule sets. In the event that a hospital or organizational unit requires the expert system server to be installed on-site, the necessary hardware and software can be setup within the hospital's data center as part of the hospital IS. In such a scenario, the rule set repository would be updated as required and can be specific to the needs of the institution.

All communication between the hospital IS and the DT and OA modules should preferably be secure and encrypted high speed communications between institution servers. Communication may be implemented on a Virtual Private Network Service delivering encrypted site-to-site communications, as is well-known in the art.

As there will preferably be no email or file server capability on these servers and no direct access by anyone other than the system administrator will be authorized, the chance of a virus finding its way onto the system is minimized. However, anti-virus software may be installed on the expert system servers and will be setup to frequently obtain virus definitions automatically. Full system scans will be performed as part of the regular maintenance schedule at times when the servers are not busy.

The design and implementation of the hardware necessary to implement the present invention is well within the ordinary skill of one skilled in the art of computer networks. A particular design is not necessarily an essential element of the invention unless specifically claimed as such herein.

As will be apparent to those skilled in the art, various modifications, adaptations and variations of the foregoing specific disclosure can be made without departing from the scope of the invention claimed herein. The various features and elements of the described invention may be combined in a manner different from the combinations described or claimed herein, without departing from the scope of the invention.

### EXAMPLES

The following examples are intended to describe a specific embodiment of the present invention and not to limit the claimed invention.

### Example 1

### Example of DT Rule Application

This example is a hypothetical case of a male undergoing a knee arthroscopy that develops an anaphylactic reaction to Cefazolin™. The antibiotic Cefazolin™ has the potential of causing an anaphylactic reaction in 10% of patients who are allergic to penicillin.

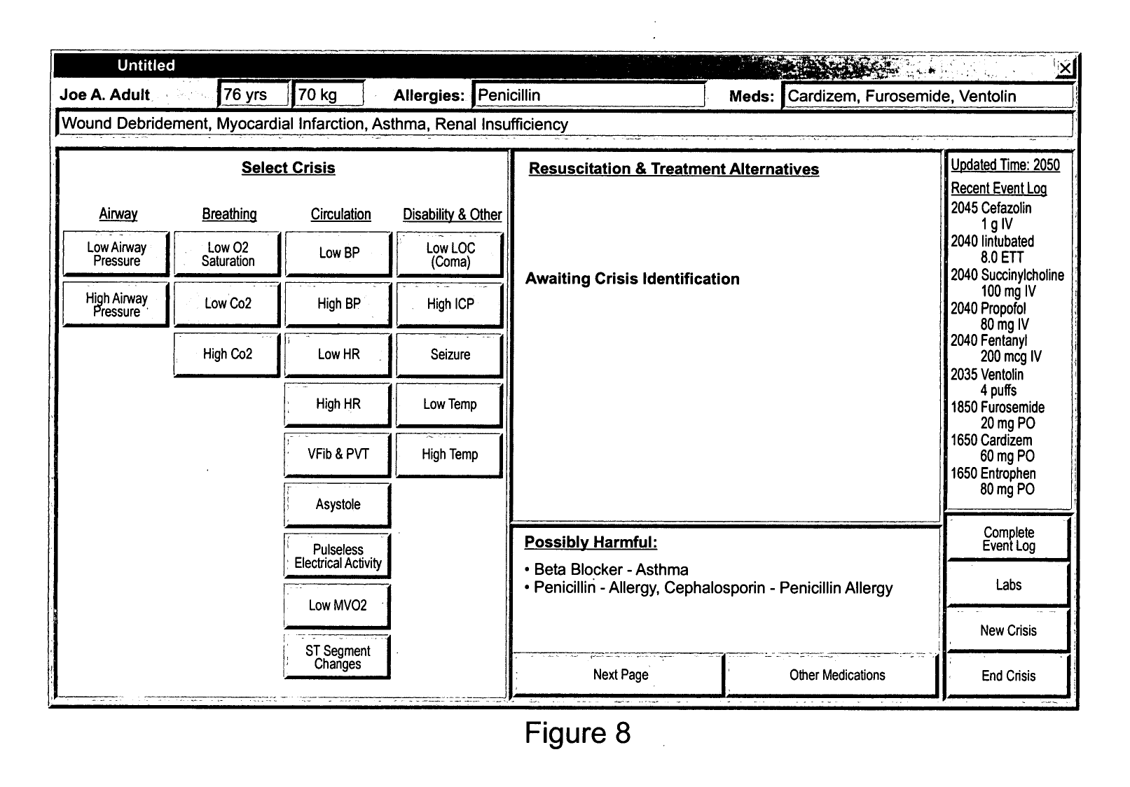

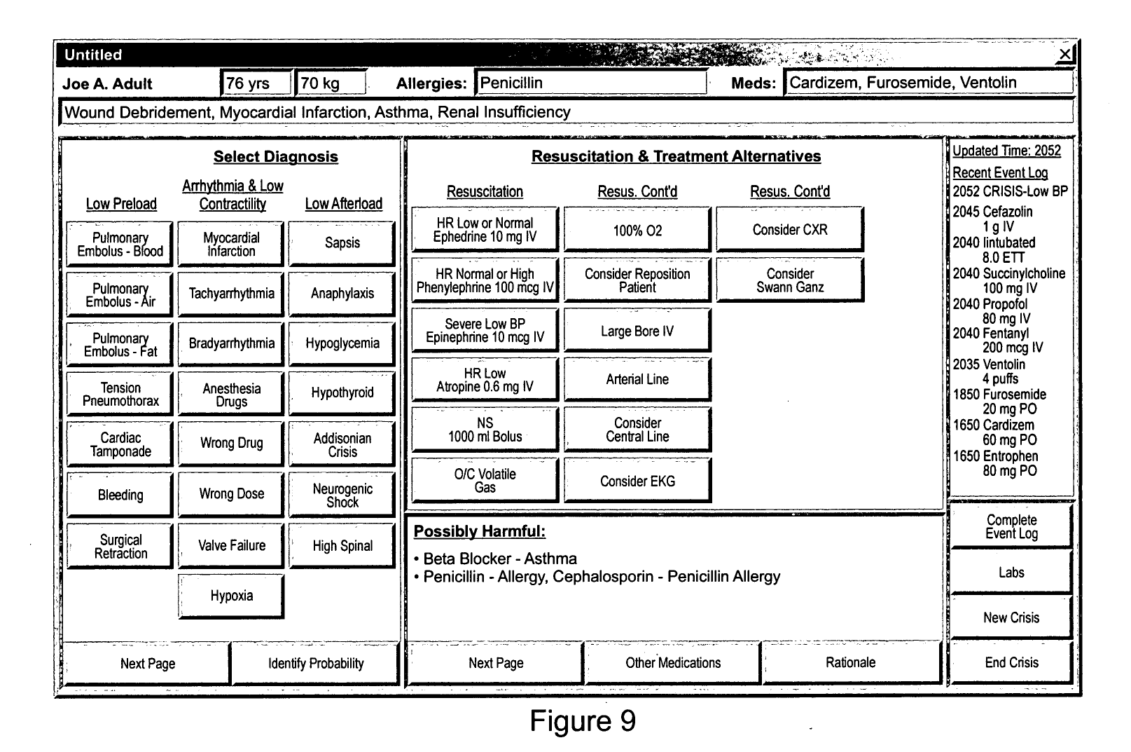

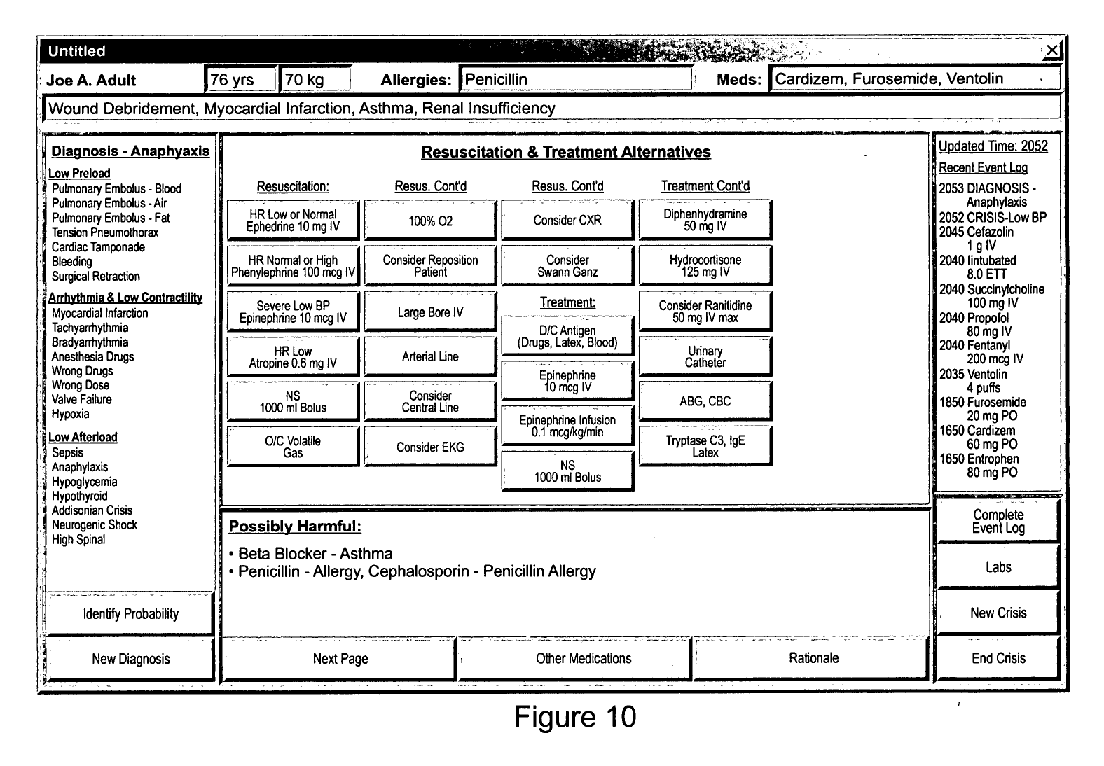

After the user identifies a crisis is occurring by activating the crisis button on the Information System (IS) main screen (not shown), the Crisis screen would appear on the IS as shown in FIG. 8.

The screen shot shown in FIG. 8 includes a patient information frame at the top and the data fields within the frame are automatically completed by the IS. The expert system would analyze which vital signs are abnormal and present all the possible crises that might be occurring to the patient in the crisis identification frame. The selections under the crisis frame would each have a button that the User could select in a single action (click as hypertext) identifying the patient's most important crisis problem to the IS and the DT Expert system. As in this case, there can be multiple crises occurring to the patient. In this case, the most important problem is hypotension, though hypoxia and tachycardia are also occurring. The user must select the most important one. When the User chooses the particular crisis, the Differential Diagnoses frame would be populated by the Expert System with the list of possible diagnoses. Those diagnoses with the highest probability of being the correct diagnosis, would be highlighted in some way. In this case, the high probability diagnoses are highlighted by red text and placement at the top of the list. Alternative presentations are possible.

When the User makes the diagnosis, the treatment for the particular diagnosis, in this case Anaphylaxis, would be displayed. An arrow between the buttons is displayed to show the order of execution of these steps.

The Resuscitation steps would be identified by the DT system so that the User has valid resuscitation alternatives to use while trying to determine the diagnosis and before definitive treatment has begun.

In addition, the Harmful Treatment frame would be populated by the DT Expert System. In this example, the patient's history of asthma will result in the display that any beta blocker medication is potentially harmful. The use of a beta blocker might be considered by users trying to treat the tachycardia (fast heart rate) but would in fact, be harmful for this asthmatic patient. “Beta blocker” is not displayed in a button format because this is not an alternative that the user should attempt to choose. Other ways of displaying harmful treatments might be appropriate to clearly identify it from possibly beneficial treatments.

When the user selects any button, there may be a change in the button such as different shading to show that the step has been done. For example, when the Epinephrine 10 mcg IV bolus has been given and documented through the user's choice of the button, the appearance of the button would change so it is clear that this action has been completed. Since the Epinephrine bolus may be given more than once, the button may indicate the total dose given and time of the last dose.

The user can select the Trend button to see a graphical and numerical display of the relevant patient data that has been recorded for various periods of time. This data would include the patient's vital signs, fluid intake and fluid output.

By activating the Log button, the user can see a list of all treatments, diagnostic tests and procedures that have occurred in the past 24 hours or other time period. In a list or other format, the user can quickly see the most recent treatments given to the patient including the medications, dose, route and the time given.

The Crisis ended button or some other alternative allows the user to declare the crisis has ended and return to the previous screen used by the Information System

### Example 2

### Examples of Crisis Situations

The following events may be considered a critical adverse event by a DT system. A differential diagnosis list is needed for each crisis:
1. Seizure
2. Reduced Level of Consciousness/Change in Mental Status
3. Increased Intracranial Pressure (ICP)
4. High Peak Inspiratory Pressure
5. Low Peak Inspiratory Pressure
6. High Plateau Airway Pressure
7. Low Plateau Inspiratory Pressure
8. Stridor
9. Hypoxia (Low oxygen saturation)
10. Hypocarbia (low CO2)
11. Hypercarbia (high CO2)
12. Failure to Breathe
13. Arrhythmia
14. Hypotension (Low blood pressure)
15. Hypertension (High blood pressure)
16. Raised ST segment
17. Low ST segment
18. Low MvO2 (low mixed venous oxygen)
19. Hyperthermia (high temperature)
20. Hypothermia (low temperature)
21. Oliguria
22. Paralysis

### Example 3

### Examples of Diagnoses

Neurological
1. Subarachnoid hemorrhage
2. High spinal—total spinal
3. Stroke
4. Cerebral edema
5. Residual muscle relaxant
6. Epidural Hematoma
7. Epidural Abscess
8. Post Dural Puncture Headache

Airway
1. Pulmonary Hemorrhage—Hemoptysis
2. Laryngospasm
3. Masseter muscle spasm
4. Epiglottitis
5. Airway fire (burn)
6. Low FiO2 delivery
7. Foreign Body
8. Endobronchial intubation
9. Endotracheal tube cuff herniation

Respiratory
1. Bronchospasm—Asthma exacerbation
2. Tension pneumothorax
3. Aspiration
4. Pulmonary embolus—blood
5. Pulmonary embolus—air
6. Pulmonary embolus—fat
7. Pulmonary embolus—amniotic fluid
8. Pulmonary embolus—cement
9. ARDS (acute respiratory distress syndrome)
10. Pulmonary edema
11. Autonomic dysreflexia

Cardiac
1. Myocardial infarction
2. Cardiac tamponade
3. Sinus bradycardia
4. Asystole
5. Second degree AV heart block
6. Third degree AV heart block
7. Atrial fibrillation
8. Atrial flutter
9. Supraventricular tachycardia
10. Ventricular tachycardia
11. Ventricular fibrillation
12. Pulse less Electrical Activity (EMD)
13. Congestive heart failure
14. Essential Hypertension
15. Cardiomyopathy

Renal
1. Metabolic Acidosis
2. Renal artery stenosis

Metabolic
1. Malignant Hyperthermia

Hematologic
1. DIC (Disseminated intravascular coagulation)
2. Transfusion Reaction
3. Bleeding (anemia)

Immune
1. Anaphylaxis
2. Anaphylactoid Reaction
3. Sepsis (SIRS)

Endocrine
1. Thyroid storm
2. Malignant Hyperthermia
3. Addisonian Crisis—Adrenal insufficiency
4. Hypoglycemia
5. Hyperglycemia
6. Hypocalcemia (low calcium)
7. Hypercalcemia
8. Hypokalemia (low potassium)
9. Hyperkalemia
10. Pheochromocytoma

Psychiatry
1. ASA Overdose
2. Tricyclic Antidepressant Overdose
3. Cocaine Use

Obstetrics
1. Pregnancy Induced Hypertension
2. Eclampsia

Iatrogenic
1. Drug overdose
2. Wrong drug—syringe swap or wrong drug choice

### Example 4

### Examples of Possible Adverse Events and Critical Events without Treatment Algorithms

Airway
1. Chipped, broken or damaged teeth
2. Oral trauma
3. Inadvertent extubation
4. Epistaxis

Respiratory
1. Ventilator Circuit disconnection
2. Ventilator failure

Cardiac
1. Intravenous line disconnection or failure
2. Arrhythmia that is temporary and not in need of treatment

Equipment Issues
1. Circle Valve stuck—open or closed
2. Power failure
3. Intravenous failure
4. Ventilator failure
5. Oxygen supply failure
6. Ventilator circuit failure or leak
7. EKG failure
8. Pulse Oximeter failure
9. Pressure transducer failure
10. Non-invasive blood pressure failure
11. Cell saver failure
12. Suction failure
13. Vaporizer failure
14. Fluid warmer failure
15. Cardiopulmonary bypass machine failure
16. Infusion pump failure
17. Warming blanket failure
18. Broken Epidural catheter
19. Broken regional catheter
20. Broken Epidural needle
21. Broken Spinal needle
22. Broken regional needle
23. Fiber optic bronchoscope failure
24. Laryngoscope failure

### Example 5

### Possible Patient Data

Patient data can be obtained from multiple sources. The following table is a partial list of possible patient data and some of their usual sources. The type of data includes ventilator information (V), patient monitor data (M), manually entered data from any source (M), peripheral device data (P), data obtained from calculations (C), and data generated by other software (S).

| | | |
|---|---|---|
| Data Code | Type | Description |

General Data

| | | |
|---|---|---|
| Age | E | |
| Weight | E | Patient weight |
| Height | E | |
| BSA | Calc | Body surface area |
| Patient Data | | |
| Medications | E | For each medication - name, |
| | | dose, route, when given |
| Allergies | E | Allergies - Drug, food, envi- |
| | | ronmental allergies and |
| | | reactions |
| Past Medical History | E | Medical problems |
| Past Surgical History | E | Procedures and dates |
| Procedure History | E | Recent procedures, dates and |
| | | times (spinal, central line, |
| | | intubation etc) |
| Fluid Intake History | E | Type of fluid, amount, route, |
| | | total fluid intake |
| Fluid Output History | E | Type of fluid, amount, route, |
| | | total fluid output |
| Net Fluid Balance | C | Total fluid intake - total fluid |
| | | output |
| Past Medical Imaging | S | Recent medical imaging re- |
| | | sults (EKG, chest x-ray, CT |
| | | scan, etc) |
| Laboratory Data | | |
| CBC | S | WBC, Hgb., Hct., |
| Electrolytes | S | Na, K, Cl, Mg, Ca, PO4, |
| | | Creatinine, Urea, Glucose |
| Arterial Blood Gas | S | pH, PCO2, PO2, Base, |
| | | HCO3, Hb, FO2Hb, FCOHb, |
| | | FMetHb, Na, K, Na, Cl, Ca, |
| | | Glu, Lactate, Hct, Baro- |
| | | metric pressure |
| Coagulation | S | INR, Ptt, Fibrinogen, D- |
| | | Dimer |
| Cardiac Enzymes | S | CK-MB, Troponin |
| Renal Function | S | Creatinine, Urea |
| Liver Function | S | GGT, AST, ALT, Alk. Phos |
| Airway Data | | |
| Peak Inspiratory Pressure | M | Peak inspiratory pressure |
| Plateau Inspiratory Pressure | M | Plateau inspiratory pressure |
| Peak Airway Pressure | M | Peak airway pressure |
| Minimal Airway Pressure | V | |
| Working Pressure | V | |
| PEEP | V | Positive end expiratory pres- |
| | | sure |
| Maximum Breath Pressure | V | Maximum pressure for venti- |
| | | lator breath |
| Respiratory Data | | |
| Inspired O2 | M | Inspired oxygen |
| Expired O2 fraction | M | |
| FiO2 set | M | Set Fractional inspired oxygen |
| O2 Flow rate | V | In LPM |
| Air Flow rate | V | |
| Total Gas flow rate | V | |
| SpO2 | M | Oxygen saturation |
| Inspired CO2 | M | |
| EtCO2 | M | End tidal CO2 |
| Respiratory Compliance | M | |
| Total Ventilator Respiratory Rate | M | Total ventilator respiratory |
| | | rate |
| Tidal Volume expired | M | Measured expired tidal |
| | | volume |
| Tidal volume set | V | Set ventilator tidal volume |
| Ventilation Mode | V | Ventilation mode |
| | | (VC—volume controlled, |
| | | PC—pressure controlled, |
| | | SIMV, |
| Inspiratory Time | V | |
| Inspiratory Flow | V | |
| Pause time (%) | V | |
| Derived Alveolar Oxygen Tension | | |
| Minute volume expired | M | |
| Cardiac Data | | |
| HR | M | Heart Rate from EKG |
| HR Pulse Oximeter | M | Heart Rate from Pulse oxi- |
| | | meter |
| NISBP | M | Non invasive systolic blood |
| | | pressure (arm, thigh) |
| NIDBP | M | Non invasive diastolic blood |
| | | pressure |
| NIMBP | M | Non invasive mean blood |
| | | pressure |
| SBP Art | M | Systolic blood pressure |
| | | arterial (radial, femoral, etc) |
| DBP Art | M | Diastolic arterial blood |
| | | pressure |
| MAP Art | M | Mean arterial blood pressure |
| Cardiac Rhythm | E | EKG rhythm |
| ST I | M | ST segment height Lead I |
| ST II | M | ST segment height Lead II |
| ST V | M | ST segment height Lead V |
| CVP | M | Central venous pressure |
| PAS | M | Pulmonary artery systolic |
| | | pressure |
| PAD | M | Pulmonary artery diastolic |
| | | pressure |
| PA Mean | M | Pulmonary artery mean |
| | | pressure |
| PCWP | M | Pulmonary capillary wedge |
| | | pressure |
| CI | C | Cardiac index |
| CO | C | Cardiac output |
| SV | C | Stroke volume |
| SVR | C | Systemic vascular resistance |
| MvO2 | C | Mixed venous oxygen satura- |
| | | tion |
| RA | M | Right atrial mean pressure |
| LA | M | Left atrial mean pressure |
| Neurologic Data | | |
| Inspired N2O % | M | Inspired Nitrous Oxide |
| Expired N2O fraction | M | Expired (end tidal) nitrous |
| | | oxide |
| N2O Setting | V | |
| N2O flow rate | V | |
| Inspired Desflurane ™ | M | |
| Et Desflurane ™ | M | |
| Desflurane ™ Setting | V | |
| Inspired Enflurane ™ | M | |
| Et Enflurane ™ | M | |
| Enflurane ™ Setting | V | |
| Inspired Halothane ™ | M | |
| Et Halothane ™ | M | |
| Halothane Setting | V | |
| Inspired Isoflurane ™ | M | |
| Et Isoflurane ™ | M | |
| Isoflurane ™ Setting | V | |
| Inspired Sevoflurane ™ | M | |
| Et Sevoflurane ™ | M | |
| Sevoflurane ™ Setting | V | |
| MAC | M | Minimum alveolar concentra- |
| | | tion of anesthetic gases |
| ICP | | Intracranial Pressure |
| CPP | Calc | Cerebral Perfusion Pressure |
| Environmental | | |
| Blood temperature | M | |
| Axillary temperature | M | |
| Transcutaneous temperature | M | |
| Esophageal temperature | M | |
| Nasal temperature | M | |
| Airway temperature | M | |

### Example 6

### Calculated Patient Data

Data necessary for calculation provided by modules, manual entry or from interface with other software. Some of the patient data requiring calculations includes:

SVR (Systemic Vascular Resistance)

CPP (Cerebral Perfusion Pressure)

Alveolar Oxygen Concentration

Body Surface Area

### Example 7

### Typical Patient Data Collected

Intubated/Ventilated Patient with N₂O/Desflurane™ Anesthesia

The following patient data may be collected and then analyzed by the decision support system for a patient undergoing general anesthesia Airway (A)
PIP, Peak airway pressure, Maximum airway pressure

Respiratory (B)
Inspired Oxygen Fraction, Expired Oxygen Fraction, Oxygen gas flow, Total gas flow, SpO2, Inspired CO2, EtCO2, EtCO2 in KPa, Vent Resp Rate, FiO2, Tidal volume expired, PEEP, Inspiratory tidal volume, Respiratory rate from PCO2, Respiratory Compliance,
Respiratory mode, Inspiratory time, Pause time, Set Max Breathing pressure, Set inspiratory flow, Sigh mode, Trigger level, Pressure sensitivity, Peak airway pressure,

Cardiac (C)
HR, HR Pulse Oximeter, NISBP, NIDBP, NIMBP, ST II,

Neurological (D)
Inspired N2O, Expired N2O, N2O gas flow, In Desflurane™, Et Desflurane™, Set Desflurane™

Environmental
Nasal temperature

### Example 8

### Examples of Possible DT Rules

The following Diagnostic Rules may be applied to a case of hypotension.
If crisis is Hypotension and age is adult then myocardial infarction is possible;
If crisis is Hypotension then anaphylaxis is possible;
If crisis is Hypotension and surgical procedure is revision hip arthroplasty then pulmonary embolus is possible;
If crisis is Hypotension and age is greater than myocardial ischemia age threshold and (ST segment has increased more than threshold or ST segment has decreased more than threshold) then myocardial infraction is probable;
If crisis is Hypotension and HR is tachycardia or peak inspiratory pressure has increased more than anaphylaxis airway pressure threshold then anaphylaxis is probable;
If crisis is Hypotension and patient has had medical imaging scan with IV contrast material in last 2 hours then IV contrast anaphylaxis is possible;
If crisis is Hypotension and central venous pressure is less than volume depletion threshold then bleeding, anaphylaxis, sepsis and neurogenic shock are possible;
If crisis is Hypotension and no history of trauma or spinal cord injury then neurogenic shock is not possible;

### Example 9

### Possible Resuscitation Rules

The following resuscitation rules may apply to a generic case of hypotension.
If age is adult and heart rate is bradycardia and hypotension is moderate then first treatment is Ephedrine™ 10 mg IV bolus;
If age is adult and heart rate is normal and hypotension is moderate then first treatment is Ephedrine™ 10 mg IV bolus or Phenylephrine™ 50 mcg IV bolus;
If age is adult and hypotension is severe then first treatment is Ephedrine™ 20 mg IV bolus;
If age is adult and hypotension is severe and spinal procedure in last 30 minutes then first treatment is Epinephrine™ 10 mcg IV.

### Example 10

### Possible Treatment Rules

The following treatment rules may apply to the generic case of hypotension presented in Examples 8 and 9 above.
If diagnosis is anaphylaxis and age is adult then first treatment step is Epinephrine™ 10 mcg IV doubling dose every 3 minutes if not effective;
If diagnosis is anaphylaxis and age is neonate then first treatment step is Epinephrine™ 10 mcg/kg IV or 100 mcg/kg ETT repeating every 3-5 minutes;
If diagnosis is anaphylaxis and FiO2 is not equal to 100% then second treatment step is 100% Oxygen;
If diagnosis is ventricular fibrillation and age is adult then first treatment step is Defibrillate 200J;
If diagnosis is Ventricular Fibrillation and age is adult then second treatment is Defibrillate 300J;
If diagnosis is Ventricular Fibrillation and age is adult then third treatment step is Defibrillate 360 J;
If diagnosis is ventricular fibrillation and age is child then first treatment step is Defibrillate 2 J/kg;
If diagnosis is Ventricular Fibrillation and age is child then second treatment step is Defibrillate 4 J/kg;
If diagnosis is Ventricular Fibrillation and age is child then third treatment step is Defibrillate 4 J/kg;
If diagnosis is Ventricular Fibrillation and age is child or adult then fourth treatment step is CPR.

### Example 11

### Harmful Treatment Rules

If medical history includes asthma and any treatment includes any beta blocker then remove the beta blocker from the treatment step and list beta blocker as harmful medication

If medical history includes Wolfe Parkinson White syndrome and any treatment includes Digoxin™ then remove Digoxin™ from the treatment step and list Digoxin™ as harmful treatment

### Example 12

### Examples of Data Collection Rules as Part of OA Rules

If critical event then store all patient data for 6 hours before event

If critical event then store all patient data for event and 72 hours after event

If critical or adverse event then store type of practitioner that was present at time of event

If critical or adverse event then store time for additional help to arrive

If critical or adverse event then store type of practitioner to arrive first to help

If adverse event then store all patient data for 3 hours after event

### Example 13

### Examples of Outcome Analysis Rules

For each type of critical or adverse event calculate the total number by institution

For each type of critical or adverse event calculate the incidence by institution (number of events divided by total number of cases both eventful and uneventful)

### Example 14

### Examples of Reporting Rules

All automated reports are distributed to OA committee as they are available

Automated reports that are within the mandate of national or international patient safety or event reporting agencies are distributed as they are available

Significant changes to practice guidelines and DT rules are distributed to users when they are available

As will be apparent to those skilled in the art, various modifications, adaptations and variations of the foregoing specific disclosure can be made without departing from the scope of the invention claimed herein. The various features and elements of the described invention may be combined in a manner different from the combinations described or claimed herein, without departing from the scope of the invention

What is claimed is:

1. A computer-implemented method of supplying diagnostic or treatment information, or both, to a health professional, comprising the steps of:
(a) creating a database of diagnosis and treatment rules;
(b) collecting patient-specific information;
(c) applying the diagnosis and treatment rules to the patient-specific information and determining suitable diagnostic or treatment information, or both;
(d) collecting outcome information including actual treatment and patient response information; and
(e) modifying the database of diagnosis and treatment rules in accordance with the outcome information.

2. The method of claim 1 wherein said diagnostic or treatment information is relevant to critical or non-critical adverse medical events.

3. The method of claim 2 wherein the patient-specific information comprises one, some or all of the following: age, weight, sex, medical history, recent medications, current or past surgical procedures, current vital signs, or current medical condition.

4. The method of claim 2 wherein diagnosis and treatment rules include information specific to an institution in a particular geographical location.

5. The method of claim 3 wherein the suitable diagnostic information comprises at least two different diagnoses separately ranked in order of higher probability.

6. The method of claim 3 wherein the suitable treatment information comprises at least two different treatment alternatives separately ranked in order of higher likelihood of success.

7. The method of claim 1 wherein the outcome information does not include information which could identify the patient, the institution or the health professional.

8. The method of claim 1 wherein the outcome information is collected from more than one institution or location.

9. A medical decision support system including a hospital information system including at least one user workstation, said system comprising:
(a) at least one server comprising:
a database comprising diagnosis and treatment rules;
means for modifying the diagnosis and treatment rules in accordance with outcome information;
a database comprising patient-specific information; and
means for generating diagnostic or treatment options by comparing the patient-specific information to the rules database;
(b) a second server, which may be the same as the at least one server, comprising a database of outcome events and outcome data, and means for generating pre-defined reports and ad-hoc reports;
(c) wherein the at least one workstation comprises:
a data interface for collecting patient-specific information and transmitting it to the server;
a user interface for receiving and displaying the diagnostic or treatment options; and
(d) and wherein a second workstation, which may be the same as the at least one workstation, comprises:
an outcome interface for collecting outcome information and transmitting it to the second server; and
a report interface for receiving and displaying reports received from the second server.

10. The medical decision support system of claim 9 wherein the data interface and user interface are provided by a first workstation and the outcome interface and report interface are provided by a second workstation.

11. The medical decision support system of claim 10 wherein the at least one server and the second server are separate servers.

12. The medical decision support system of claim 11 wherein the at least one server and the at least one workstation are connected by a local area network, a wide area network, or the Internet.

13. The medical decision support system of claim 9 wherein one or more of the data interface, user interface, outcome interface and report interface is a web browser.

14. The medical decision support system of claim 13 wherein the user interface comprises a touch-sensitive screen.

15. The medical decision support system of claim 9 comprising a plurality of user workstations in at least two different locations or institutions.
